(19) United States
(12) Patent Application Publication
(10) Pub. No.: US 2013/0340075 A1
(43) Pub. Date: Dec. 19, 2013

(54) ENHANCED DATA PROTECTION FOR MESSAGE VOLUMES

(71) Applicants: Shuab Khan, Seattle, WA (US); Nikita Kozhekin, Redmond, WA (US); Ravikumar Venkateswar, Redmond, WA (US); Greg Thiel, Black Diamond, WA (US); Yogesh Bansal, Redmond, WA (US); Dmitry Sarkisov, Redmond, WA (US)

(72) Inventors: Shuab Khan, Seattle, WA (US); Nikita Kozhekin, Redmond, WA (US); Ravikumar Venkateswar, Redmond, WA (US); Greg Thiel, Black Diamond, WA (US); Yogesh Bansal, Redmond, WA (US); Dmitry Sarkisov, Redmond, WA (US)

(73) Assignee: Microsoft Corporation, Redmond, WA (US)

(21) Appl. No.: 13/526,993

(22) Filed: Jun. 19, 2012

(51) Int. Cl. G06F 21/00

(52) U.S. Cl. 726/22; 726/26

(57) ABSTRACT

In a message replication environment, instances of a message volume are hosted by message systems. Each message system exchanges condition information with the other message systems indicative of the health of the volume instance hosted by the message system. Each message system then determines independently from the other message systems whether or not the message volume is sufficiently protected. In the event that the message volume is insufficiently protected, a protection action can be initiated.

### TECHNICAL FIELD

Aspects of the disclosure are related to computing and communications, and in particular to protecting data in message services.

### TECHNICAL BACKGROUND

Message services are increasingly depended upon by users to handle their vital communications, such as email, telephony, and video communications. Many different data protection solutions are employed to protect data in message environments, including data replication solutions. Data replication typically involves creating copies of data volumes and updating the copies as modifications are made to the source data volumes. For example, active databases in email systems can be replicated to redundant, passive databases.

Data protection solutions can be monitored to ensure that they are operating properly. In many such monitoring implementations, alerts are generated when systems or process failures place data at risk. For example, a computing system that hosts a message database in an email system may generate an alert upon the failure of physical or logical elements within the system, such as failed memory, stalled processes, or the like. Personnel can then be dispatched or automated repair solutions initiated to fix or compensate for the failure.

Sometimes the failure of an element within a data protection solution prevents the element from reporting its failed state to a monitoring system. Other times, a failure may trigger an alert that is treated with substantial urgency even though the data is well protected by sufficient redundancy in the data protection solution. In either case, the effectiveness of the data protection is inhibited. In the first case, the failure may reduce redundancy, while in the second case the urgency required by the alert may waste resources and eventually erode the urgency given to future alerts.

### OVERVIEW

Provided herein are systems, methods, and software that provide enhanced data protection for message volumes. In a message replication environment, instances of a message volume are hosted by message systems. Each message system exchanges condition information with the other message systems indicative of the health of the volume instance hosted by the message system. Each message system then determines independently from the other message systems whether or not the message volume is sufficiently protected. In the event that the message volume is insufficiently protected, a protection action can be initiated.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a data protection environment in an implementation.

FIG. 2 illustrates an enhanced protection process in an implementation.

FIG. 3 illustrates a message system in an implementation.

FIG. 4 illustrates a data protection environment in an implementation.

FIG. 5 illustrates an enhanced protection process in an implementation.

FIG. 6 illustrates several views of a decision matrix and several views of a graph describing the relationship between latency and risk of data loss and the relationship between redundancy and risk of data loss in an implementation.

FIG. 7 illustrates a message system in an implementation.

FIG. 8 illustrates a message system in an implementation.

### TECHNICAL DISCLOSURE

Implementations described herein provide for enhanced data protection of message volumes. In the disclosed implementations, message systems that host message volumes exchange condition information with each other indicative of the health of their respective message volumes. Each individual message system can then determine independent from the other message systems the level of protection provided by the message volumes. Should the level of protection be considered insufficient, protective actions can commence, such as alerting personnel, initiating repair processes, or otherwise taking steps to provide sufficient data protection.

In some implementations, the enhanced data protection is imbedded in or integrated with a replication process that is employed by each message server. The replication process may replicate a source volume to each message server, or may replicate a source volume hosted by the message server to other volumes. Regardless, enhanced data protection is provided by way of intercommunication between the various message servers to independently assess how sufficiently or insufficiently a message volume may be protected.

By having each message system generate its own assessment of the health of a protection solution, duplicate alerts or other warnings may be generated in the event of an element failure or other similar impairment. While duplicate alerts may not be optimal, the risk of providing no alert at all is reduced. This may be especially helpful in the event that a failure prevents a message system from providing any alert at all. In fact, the message system can be assumed to have failed by other message system should the message system be unable to communicate health information, status, alerts, or other relevant information to the other message systems. The other message systems can then alert a monitoring system to the failure.

The parameters by which the health of a message volume, or indeed the health of a protection solution overall, is measured may be user-definable, dependent upon business considerations, or otherwise configurable on a per-implementation basis. In fact, the enhanced data protection can be configured such that various health factors are balanced in accordance with any number of considerations. For example, redundancy and latency thresholds may be configured differently on a per-customer, region, data center, or application basis, as well as any combination of variation thereof. The specific architecture employed and the specific goals of a data protection solution can impact how parameters are set, and thus how enhanced data protection is implemented.

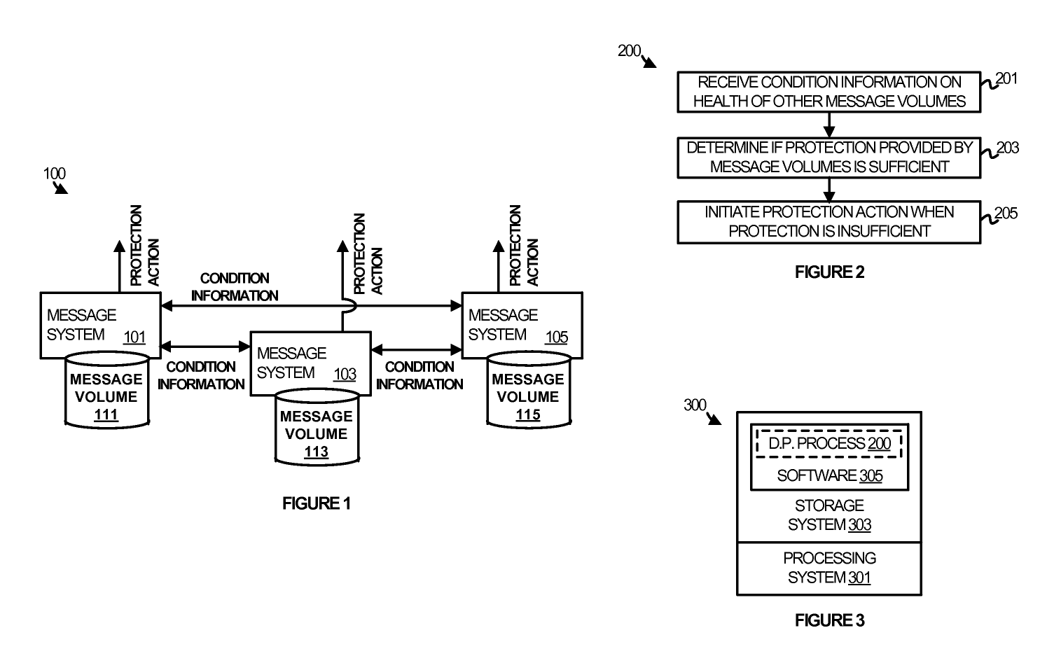

Referring now to the drawings, FIGS. 1-3 illustrate one implementation of enhanced data protection. FIG. 1 illustrates a data protection environment in which an enhanced data protection process illustrated in FIG. 2 may be employed. FIG. 3 illustrates an exemplary computing system for implementing the data protection process.

Turning to FIG. 1 in more detail, message replication environment 100 includes message system 101, message system 103, and message system 105. Message system 101 hosts message volume 111, message system 103 hosts message volume 113, and message system 105 hosts message volume 115. Message replication environment 100 may include additional message systems or volumes and is not limited merely to those described herein.

Message systems 101, 103, and 105 are each representative of any system or collection of systems capable of hosting a message volume or volumes, exchanging condition information with other message systems, and performing an enhanced protection process to provide enhanced data protection for the message volume. Message systems 101, 103, and 105 may each be capable of performing other processes and functions and should not be limited to just those capabilities described herein. It should be understood that message systems 101, 103, and 105 may perform similar functions as one another, or may perform different functions relative to one another. Message system 300, described in more detail below with respect to FIG. 3, is an example of a computer system suitable for implementing message systems 101, 103, and 105.

Message volumes 111, 113, and 115 are each representative of any data volume capable of having messages stored therein. In addition, message volumes 111, 113, and 115 may each be representative of any data volume capable of being written to with message data and capable of having message data read therefrom. Messages volumes 111, 113, and 115 may be stored on storage systems, an example of which is provided by storage system 303 below with respect to FIG. 3.

Message volumes 111, 113, and 115 are each an instance of a message volume for which data protection is employed. For instance, message volumes 111, 113, and 115 may be copies or replicas of a source data volume (not shown) made for purposes of data protection. Optionally, any of message volumes 111, 113, and 115 may itself be the source data volume from which copies are derived for purposes of data protection. While message volumes 111, 113, and 115 are each instances of a message volume, they may vary from one another in some respects. For example, one or another message volume may be more current than the other message volumes, may have a different format than the other message volumes, or may vary in other ways.

In operation, each message system in message replication environment 100 may implement enhanced protection process 200. Referring to FIG. 2, message systems 101, 103, and 105 each receive condition information from each other message system indicative of the health of the message volume hosted by the message system (step 201). For example, message system 101 provides condition information related to the health of message volume 111 to message systems 103 and 105; message system 105 provides condition information related to the health of message volume 113 to message systems 101 and 105; and message system 105 provides condition information on the health of message volume 115 to message systems 101 and 103.

It should be understood that receiving no condition information at all may itself me considered condition information. For example, should message system 105 fail to provide condition information to either or both of message systems 101 and 103, then message systems 101 and 103 may interpret that lack of condition information as indicative of the failure of or otherwise unhealthy state of message system 105 or message volume 115.

Each message system in message replication environment 100 can then determine independently from the other message systems whether or not the message volume, of which message volumes 111, 113, and 115 are instances, is sufficiently protected (step 203). This determination may be made based on the condition information provided by the other message systems and protection criteria against which the condition information may be analyzed. However, the determination may also be made based on the health of the message volume hosted by each respective message system.

For example, message system 101 would determine the sufficiency of the data protection based on the condition information provided by message systems 103 and 105, but also based on the health of message volume 111. Similarly, message system 103 would determine the sufficiency of the data protection based on the condition information provided by message systems 101 and 105, but also based on the health of message volume 113. Message system 105 would determine the sufficiency of the data protection based on the condition information provided by message systems 101 and 103, but also based on the health of message volume 115.

The sufficiency of the data protection assessed by message systems 101, 103, and 105 may be based on a number of factors included in the protection criteria. For example, an actual level of redundancy provided by the message systems may be compared to a threshold level of redundancy. When the actual level of redundancy fails to satisfy the threshold level, the level of data protection may be considered insufficient. Whether or not a particular message volume provides redundancy can be determined from the condition information provided by its associated message system. The health of the message volume, or even the health of the message system, can be considered when determining whether or not the message volume contributes to redundancy. For instance, processing loads placed on the message systems, operating performance of the message system, or actual latency of the message volume relative to the source message volume are aspects or factors considered when assessing redundancy.

Having independently determined a view of the level of protection provided by the message volumes, each message system is capable of initiating a protection action in the event that the data protection is determined to be insufficient (step 205). Examples of the protection action include generating an alert indicative of the insufficient state of the data protection or launching a repair process, as well other types of protection actions.

Since each message system is capable of independently determining whether or not the message volume is sufficiently protected, situations may be avoided where the failure of a system or sub-system is under-reported or not reported at all. In addition, by each message system independently analyzing the health of the message volumes hosted by the other message systems, a more comprehensive view of the level of protection provided by the message volumes can be determined.

Referring now FIG. 3, message system 300 and the associated discussion are intended to provide a brief, general description of a computing system suitable for implementing enhanced protection process 200. Many other configurations of computing devices and software computing systems may be employed to implement enhanced protection process 200. As mentioned above, message system 300 may be representative of message systems 101, 103, and 105.

Message system 300 may be any type of computing system capable of determining if data protection is insufficient and initiating a protection action accordingly, such as a server computer, client computer, internet appliance, or any combination or variation thereof. Indeed, message system 300 may be implemented as a single computing system, but may also be implemented in a distributed manner across multiple computing systems. Message system 300 is provided as an example of a general purpose computing system that, when implementing enhanced protection process 200, becomes a specialized system capable of supporting enhanced data protection in message services.

Message system 300 includes processing system 301, storage system 303, and software 305. Processing system 301 is communicatively coupled with storage system 303. Storage system 303 stores software 305 which, when executed by processing system 301, directs message system 300 to operate as described for enhanced protection process 200.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device.

Storage system 303 may comprise any storage media readable by processing system 301 and capable of storing software 305. Storage system 303 may include volatile and nonvolatile, removable and non-removable media implemented in any method or technology for storage of information, such as computer readable instructions, data structures, program modules, or other data. Storage system 303 may be implemented as a single storage device but may also be implemented across multiple storage devices or sub-systems. Storage system 303 may comprise additional elements, such as a controller, capable of communicating with processing system 301.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 305 comprises computer program instructions, firmware, or some other form of machine-readable processing instructions having enhanced protection process 200 embodied therein. Software 305 may be implemented as a single application but also as multiple applications. Software 305 may be a stand-alone application but may also be implemented within other applications distributed on multiple devices.

In general, software 305 may, when loaded into processing system 301 and executed, transform processing system 301, and message system 300 overall, from a general-purpose computing system into a special-purpose computing system customized to receive condition information related to the health of instances of a message volume, determine if a level of protection provided for the message volume is sufficient, and initiate a protection action when the protection is insufficient, as described for enhanced protection process 200 and its associated discussion.

The physical structure of storage system 303 may also be transformed as software 305 is encoded thereon. The specific transformation of the physical structure may depend on various factors in different implementations of this description. Examples of such factors may include, but are not limited to: the technology used to implement the storage media of storage system 303, whether the computer-storage media are characterized as primary or secondary storage, and the like.

For example, if the computer-storage media are implemented as semiconductor-based memory, software 305 may transform the physical state of the semiconductor memory when the software is encoded therein. Software 305 may transform the state of transistors, capacitors, or other discrete circuit elements constituting the semiconductor memory.

A similar transformation may occur with respect to magnetic or optical media. Other transformations of physical media are possible without departing from the scope of the present description, with the foregoing examples provided only to facilitate this discussion.

Referring again to FIG. 1, through the operation of any of message systems 101, 103, and 105 implemented using a computing system such as message system 300 employing software 305, transformations may be performed in message replication environment 100. As an example, any of message systems 101, 103, and 105 could be considered transformed from one state to another when triggered to initiate a protection action in response to detecting an insufficient level of protection in message replication environment 100.

Message system 300 may have additional devices, features, or functionality. Message system 300 may optionally have input devices such as a keyboard, a mouse, a voice input device, or a touch input device, and comparable input devices. Output devices such as a display, speakers, printer, and other types of output devices may also be included. Message system 300 may also contain communication connections and devices that allow message system 300 to communicate with other devices, such as over a wired or wireless network in a distributed computing and communication environment. These devices are well known in the art and need not be discussed at length here.

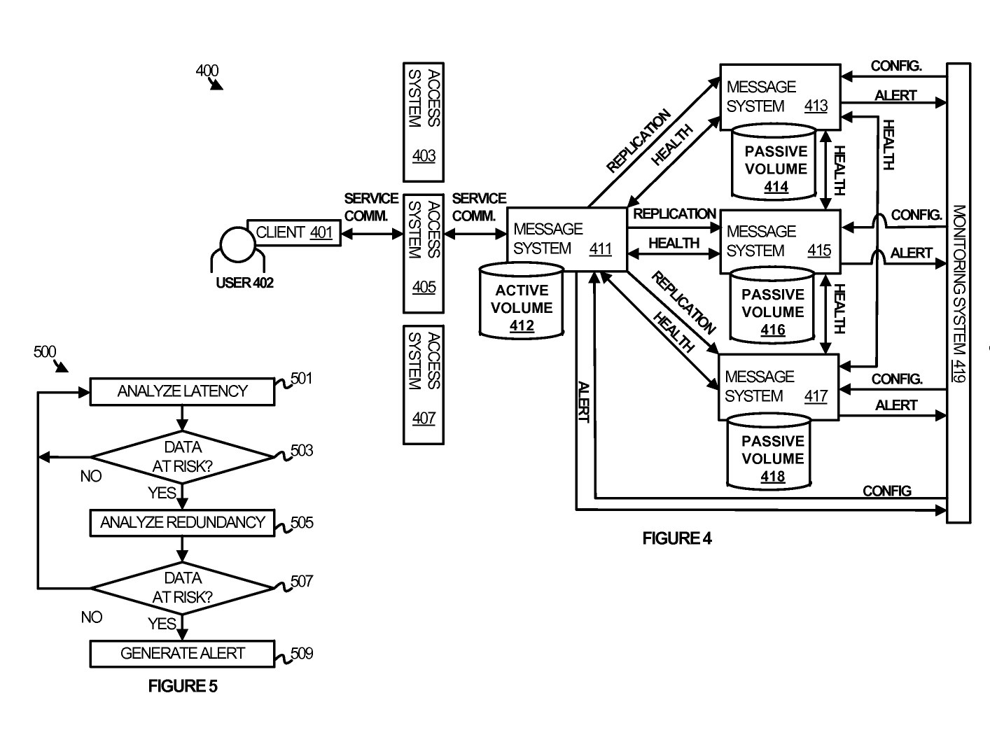

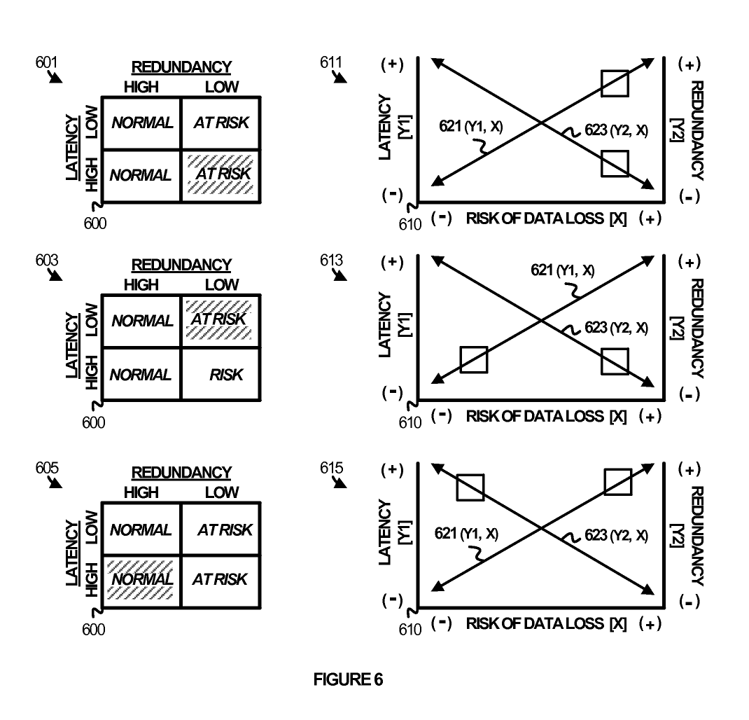

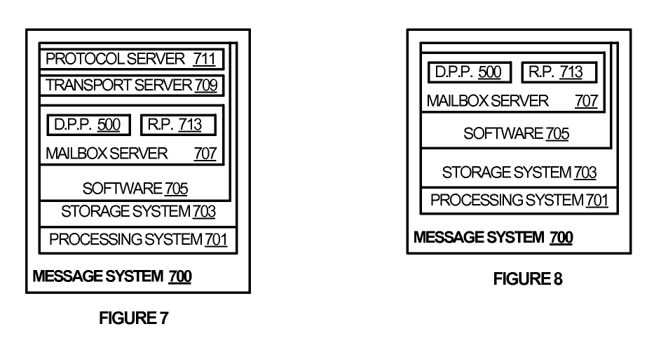

Turning now to FIGS. 4-8, illustrated is another implementation of enhanced data protection. FIG. 4 illustrates a data protection environment in which a data protection process illustrated in FIG. 5 may be employed. FIG. 6 illustrates how redundancy and latency information may be utilized for implementing the data protection process of FIG. 5. FIG. 7 and FIG. 8 illustrate variations of an exemplary message system that provides the enhanced data protection.

Referring to FIG. 4, data protection environment 400 includes client 401 in communication with message system 411 by way of any of access systems 403, 405, and 407. For exemplary purposes in this illustration client 401 exchanges service communications with message system 411 via access system 405, although client 401 may be directed to either of access system 403 or access system 407. The service communications are exchanged in order to facilitate the provisioning and delivery of a message service, such as email, to user 402. For example, client 401 may communicate with message system 411 to send and receive email on behalf of user 402. An example of an email service is Microsoft® Exchange.

Client 401 may communicate with message system 411 over a communication link using any of a variety of messaging protocols, such as Post Office Protocol (POP), Internet Message Access Protocol (IMAP), Outlook® Web App (OWA), Exchange Control Panel (ECP), or ActiveSync, to provide user 402 with access to messages and messaging functionality. The communication link may be any link or collection of links capable of carrying or otherwise facilitating communication between client 401 and message system 411, including physical links, logical links, or any combination or variation thereof.

As part of providing the message service, message system 411 hosts active volume 412. Messages associated with user 402, as well as other users, are written to and retrieved from active volume 412. In order to protect the messages, active volume 412 is replicated by to passive volumes 414, 416, and 418, hosted by message systems 413, 415, and 417 respectively. This may be accomplished by way of a replication service well known in the art that need not be discussed at length here.

Message systems 411, 413, 415, and 417 are each representative of any system or collection of systems capable of hosting a message volume or volumes, exchanging condition information with other message systems, and performing an enhanced protection process to provide enhanced data protection for the message volume. Message systems 411, 413, 415, and 417 may each be capable of performing other processes and functions and should not be limited to just those capabilities described herein. It should be understood that message systems 411, 413, 415, and 417 may perform similar functions as one another, or may perform different functions relative to one another. Message system 700, described in more detail below with respect to FIG. 7, is an example of a computer system suitable for implementing message systems 411, 413, 415, and 417.

Active volume 412 and passive volumes 414, 416, and 418 are each representative of any data volume capable of having messages stored therein. In addition, Active volume 412 and passive volumes 414, 416, and 418 may each be representative of any data volume capable of being written to with message data and capable of having message data read therefrom. Active volume 412 and passive volumes 414, 416, and 418 may be stored on storage systems, an example of which is provided by storage system 703 below with respect to FIG. 7. Examples of such volumes include active email database, passive email databases, and unified messaging databases, as well as any other type of suitable message volume.

It should be understood that active volume 412 may be designated as the active volume, but at any time one of passive volumes 414, 416, and 418 may be designated as the active volume. Active and passive designations may be controlled by availability solutions that track the availability of the components of data protection environment 400. Should one component be rendered unavailable, a failover can occur to a backup component. For example, in the event that active volume 412 is rendered unavailable, one of passive volumes 414, 416, and 418 can be designated as the new active volume. In this example, client 401 would then be directed to communicate with the proper message system of message systems 413, 415, and 417 that hosts the newly designated active volume.

As illustrated in FIG. 4, each message system 411, 413, 415, and 415 exchanges health information with each other of the message systems. For instance, message system 411 provides health information to message systems 413, 415, and 417, while at the same time receiving health information from message systems 413, 415, and 417. Each message system 411, 413, 415, and 417 can then determine, independently from the other message systems, if a message volume is sufficiently protected. In this implementation, the source message volume is active volume 412, which is replicated to passive volumes 414, 416, and 418 as discussed above. Thus, each message system 411, 413, 415, and 417 processes the health information to determine if active volume 412 is sufficiently protected.

It should be understood that receiving no information at all from any other message system can be considered to be representative of a failure of that message system. For instance, should message system 411 fail to receive health information from message system 413, then message system 411 can consider message volume 414 as unhealthy. Message system 411 can then factor that information into its assessment of how well active volume 412 is protected.

Depending upon the determination made by the message systems, alerts can be provided to monitoring system 419. Monitoring system 419 is representative of any logical or physical elements, or combinations thereof, capable of monitoring the performance and health of message systems 411, 413, 415, and 417. Monitoring system 419 is illustrated as a stand-alone element, but may also be distributed across many different elements. In response to receiving an alert from any of the message systems in data protection environment 400, monitoring system 419 is capable of taking protective action to resolve an incidence of insufficient data protection. For example, monitoring system 419 may generate and transfer alert messages to responsible personnel indicative of the insufficient state of data protection. In another example, monitoring system 419 may communicate the insufficient state to other systems, such as an availability system, so that the other systems can take protective action. In the case of an availability system, the availability system may initiate a failover from an element contributing to the insufficient state to a backup element.

In another aspect of monitoring system 419, configuration information may be provided to message systems 411, 413, 415, and 417 pertaining to parameters for determining when data protection is sufficient or insufficient. As will be discussed with respect to FIG. 5 and FIG. 6, actual latency and actual redundancy are at least two factors that may be considered when determining the state of a data protection solution. Message systems 411, 413, 415, and 417 may be configured in a number of ways, including by way of client management computers included within monitoring system 419. Optionally, message systems 411, 413, 415, and 417 may be accessible by way of a web interface from any computer, regardless of the presence of a specific management client. It should be understood that many well-known technologies exist for configuring message systems 411, 413, 415, and 417 that need not be discussed at length here.

Referring now to FIG. 5, data protection process 500 describes the operation of message systems 411, 413, 415, and 417. In particular, each message system may implement data protection process 500 independent of the other message systems when determining the state of the data protection. By considering both the health of an instance of the volume and the overall redundancy provided by a protection solution when triggering alerts, false alerts of alerts related to less urgent situations may be reduced. However, while the threshold for triggering an alert may be increased by considering both the health of an instance of a volume and redundancy provided to a subject volume, by implementing data protection process 500 in each message system a dependence upon just one particular message system is avoided. In other words, fewer alerts may be triggered by each individual message system relative to a data protection process that considers only the health of each instance or redundancy. In addition, the likelihood that a protection failure goes undetected is reduced since data protection process 500 is widely implemented.

The following discussion of data protection process 500 will proceed with respect to message system 415 for the sake of clarity. It should be understood that that principals discussed herein with respect to message system 415 would apply as well to message systems 411, 413, and 417.

At step 501, message system 415 receives health information provided by the other message systems, along with its own health information pertaining to the health of passive volume 416. Message system 415 processes the health information to determine the health of each instance of active volume 412, possibly including analyzing the health of active volume 412 itself. In other words, message system 415 determines whether or not each of passive volumes 414, 416, and 418 is healthy and capable of providing data protection.

As mentioned above, message systems 411, 413, 415, and 417 exchange health information indicative of the respective health of the message volume hosted by each message volume. The health information may indicate factors, statistics, or measurements, as well as any other data that provides a view of the health of each respective message volume. In this example, message system 415 receives health information from message systems 411, 413, and 417 indicative of the health of message volumes 412, 414, and 418 respectively.

At step 503 message system 415 determines for each instance if the data is at risk based on the individual health of each instance. Using latency as an example, should any of passive volumes 414 or 418 exhibit unusually high latency relative to active volume 412, message system 415 may consider that instance of active volume 412 to be at risk of data loss. Other characteristics may also be considered, such as simple availability. For example, if either of passive volumes 414 and 418 is entirely unavailable, then the data stored thereon would be considered at risk. Similarly, health information indicative of problematic processing characteristics, such as high processor utilization, full disk capacity, or other health-related characteristics may also be considered when assessing whether or not a particular instance of a volume is at risk of data loss.

In the event that no volume instance is considered at risk of data loss, the message system 415 returns to step 501 to continue analyzing the health of the volume instances. However, should one or more instances be at risk of data loss, then message system 415 proceeds to step 505 to analyze redundancy provided by the message volumes.

In particular, at step 505 message system 415 analyzes how many copies of active volume 412 are healthy and compares this quantity to threshold amounts specified by configuration parameters. While a volume instance may be considered at risk of data loss, the volume can still be available. Thus, the redundancy analysis provided in step 505 whether or the volume instances are available at a basic level, even if performing at a level that may present some risk of data loss.

At step 507 message system 415 determines whether or not data protection environment 400 is in a state of sufficient or insufficient protection. In other words, message system 415 determines whether or not data is at risk due to insufficient redundancy. In the event that a state of insufficient data protection is detected, message system 415 generates and alert that is communicated to monitoring system 419. Monitoring system 419 can then take appropriate action to remedy the insufficient protection. For example, personnel may be dispatched to fix an element, or automated repair process may be initiated, as well as many other appropriate actions.

However, message system 415 may also determine that sufficient redundancy exists such that the risk of data loss presented by some relative unhealthy volumes is acceptable. In this case, message system 415 returns to step 501 and continues analyzing the health of each message volume. In this manner, the frequency of alerts providing to monitoring system from any single message system can be reduced, since both the individual health of each volume instance is analyzed, as well as the overall redundancy provided in the system.

FIG. 6 illustrates several views 601, 603, and 605 of a decision matrix 600 representative of how data risk may be assessed based by message systems 411, 413, 415, and 417 when implementing data protection process 500. In particular, decision matrix 600 defines how a message system would view the risk present to data by various combinations of latency and redundancy exhibited in data protection environment 400. In addition, FIG. 6 illustrates several views 611, 613, and 615 of a graph 610 describing the relationship 621 between latency and data risk and the relationship 623 between redundancy and data risk. Graph 610 informs the view of risk defined by decision matrix 600.

In FIG. 6, latency is provided as just one example of how the health of a message volume may be measured or indicated. Referring to FIG. 5, latency information may be included in the health information exchanged between message systems. In addition, latency may be one factor considered in step 503 when assessing the risk of data loss presented by any given volume instance. It should be understood that other health factors in addition to or substituted for latency may be utilized and are considered within the scope of the present disclosure.

Referring to decision matrix 600 generally, two levels of redundancy are described—high and low. Likewise, two levels of latency are described—high and low. Thus, four combinations of redundancy and latency are considered and their associated risk assessment defined.

The risk presented by each combination is described by the relationships 621 and 623 between latency, risk, and redundancy illustrated by graph 610. Per relationship 621, as latency increases, so too does the risk of data loss. Conversely, as latency decreases, the risk of data loss also decreases. Per relationship 623, as redundancy decreases, the risk of data loss increases. Conversely, as redundancy increases, the risk of data loss decreases.

Referring to view 601 of decision matrix 600 and view 611 of graph 610, one particular example is illustrated whereby a state of high latency and low redundancy is detected by a message system implementing data protection process 500. In this example, decision matrix 600 defines that the data protection provided by data protection environment 400 is insufficient and data is at risk. Per data protection process 500, an alert or some other protection action can be taken by the message system, monitoring system 419, or some other element.

Referring to view 603 of decision matrix 600 and view 613 of graph 610, another particular example is illustrated whereby a state of low latency and low redundancy is detected by a message system implementing data protection process 500. In this example, decision matrix 600 defines that the data protection provided by data protection environment 400 is insufficient and data is at risk. Per data protection process 500, an alert or some other protection action can be taken by the message system, monitoring system 419, or some other element.

Referring to view 605 of decision matrix 600 and view 615 of graph 610, another particular example is illustrated whereby a state of high latency and high redundancy is detected by a message system implementing data protection process 500. In this example, decision matrix 600 defines that the data protection provided by data protection environment 400 is sufficient and data is at not risk. Rather, conditions can be considered normal. This example illustrates that, even though latency exhibited is high, an alert or some other protective action need not be taken since redundancy is also high.

FIG. 7 illustrates a message system 700 in an implementation. Message system 700 is exemplary of message systems 411, 413, 415, and 417. FIG. 8 illustrates an optional configuration involving message system 700.

Message system 700 includes processing system 701, storage system 703, and software 705. Software 705 includes mailbox server 707, transport server 709, and protocol server 711. Mailbox server 707 implements data protection process 500 and replication process 713. As illustrated by FIG. 8, transport server 709 and protocol server 711 may be excluded from message system 700, and perhaps integrated in some other element, such as an access system.

Message system 700 may be any type of computing system, such as a server computer, internet appliance, or any combination or variation thereof. Message system 700 may be implemented as a single computing system, but may also be implemented in a distributed manner across multiple computing systems.

Processing system 701 is communicatively coupled with storage system 703. Storage system 703 stores software 705 which, when executed by processing system 701, directs message system 700 to operate as described for data protection process 500. It should be understood that message system 700 may also be capable of operating as described for enhanced protection process 200.

Referring still to FIG. 7, processing system 701 may comprise a microprocessor and other circuitry that retrieves and executes software 705 from storage system 703. Processing system 701 may be implemented within a single processing device but may also be distributed across multiple processing devices or sub-systems that cooperate in executing program instructions. Examples of processing system 701 include general purpose central processing units, application specific processors, and logic devices, as well as any other type of processing device.

Storage system 703 may comprise any storage media readable by processing system 701 and capable of storing software 705. Storage system 703 may include volatile and nonvolatile, removable and non-removable media implemented in any method or technology for storage of information, such as computer readable instructions, data structures, program modules, or other data. Storage system 703 may be implemented as a single storage device but may also be implemented across multiple storage devices or sub-systems. Storage system 703 may comprise additional elements, such as a controller, capable of communicating with processing system 701.

Examples of storage media include random access memory, read only memory, magnetic disks, optical disks, and flash memory, as well as any combination or variation thereof, or any other type of storage media. In some implementations, the storage media may be a non-transitory storage media. In some implementations, at least a portion of the storage media may be transitory. It should be understood that in no case is the storage media a propagated signal.

Software 705 comprises computer program instructions, firmware, or some other form of machine-readable processing instructions having data protection process 500 embodied therein. Software 705 may be implemented as a single application but also as multiple applications. Software 705 may be a stand-alone application but may also be implemented within other applications distributed on multiple devices.

Message system 700 may have additional devices, features, or functionality. Message system 700 may optionally have input devices such as a keyboard, a mouse, a voice input device, or a touch input device, and comparable input devices. Output devices such as a display, speakers, printer, and other types of output devices may also be included. Message system 700 may also contain communication connections and devices that allow message system 700 to communicate with other devices, such as over a wired or wireless network in a distributed computing and communication environment. These devices are well known in the art and need not be discussed at length here.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of providing data protection for a message volume in a message replication environment comprising a plurality of message systems and a plurality of instances of the message volume hosted by the plurality of message systems, the method comprising:
each of the plurality of message systems receiving condition information from each other of the plurality of message systems comprising a health of each of the plurality of instances of the message volume;
each of the plurality of message systems determining independently from each other of the plurality of message systems when a level of protection provided by the plurality of instances of the message volume comprises an insufficient level of protection based on the condition information and protection criteria; and
each of the plurality of message systems initiating at least a protection action when the level of protection provided by the plurality instances of the message volume comprises the insufficient level of protection.

2. The method of claim 2 wherein the protection criteria comprises a threshold redundancy level, and wherein determining when the level of protection comprises the insufficient level comprises determining when the level of protection comprises the insufficient level based at least on the threshold redundancy level and an actual redundancy level provided by the plurality of instances of the message volume.

3. The method of claim 2 further comprising each of the plurality of message systems determining independently from each other of the plurality of message systems the actual redundancy level provided by the plurality of instances of the message volume based at least on the condition information.

4. The method of claim 1 wherein the protection criteria comprises a threshold latency level, and wherein determining when the level of protection comprises the insufficient level comprises determining when the level of protection comprises the insufficient level based at least on the threshold latency level and an actual latency level of at least one of the plurality of instances of the message volume.

5. The method of claim 4 further comprising each of the plurality of message systems determining independently from each other of the plurality of message systems the actual latency level provided by at least one of the plurality of instances of the message volume based at least on the condition information.

6. The method of claim 1 wherein the protection criteria comprises a threshold redundancy level and a threshold latency level, and wherein determining when the level of protection comprises the insufficient level comprises determining when the level of protection comprises the insufficient level based at least on the threshold redundancy level, an actual redundancy level, the threshold latency level, and an actual latency level.

7. The method of claim 1 wherein the plurality of message systems provide an email service, wherein the message volume comprises an active email database associated with the email service, and wherein the plurality of instances of the message volume comprises a plurality of passive email databases corresponding to the active email database.

8. The method of claim 7 further comprising replicating the active email database to the plurality of passive email databases, and wherein the protection action comprises transferring an alert to a monitoring system indicative of the insufficient level of protection.

9. One or more computer readable media having stored thereon program instructions for protecting a message volume and executable by at least one message system of a plurality of message systems in a message replication environment wherein the program instructions, when executed by the message system, direct the message system to perform steps comprising:
receive from each other of the plurality of message systems condition information comprising a health status of each of a plurality of instances of the message volume hosted by the plurality of message systems;
determine when a level of protection provided by the plurality of instances of the message volume comprises an insufficient level of protection based at least in part on protection criteria and the condition information; and
initiate at least a protection action when the level of protection provided by the plurality instances of the message volume comprises the insufficient level of protection.

10. The one or more computer readable media of claim 9 wherein the protection criteria comprises a threshold redundancy level, and wherein to determine when the level of protection comprises the insufficient level, the program instructions direct the message system to determine when the level of protection comprises the insufficient level based at least on the threshold redundancy level and an actual redundancy level provided by the plurality of instances of the message volume.

11. The one or more computer readable media of claim 10 wherein the program instructions further direct the message system to determine the actual redundancy level provided by the plurality of instances of the message volume based at least on the condition information.

12. The one or more computer readable media of claim 9 wherein the protection criteria comprises a threshold latency level, and wherein to determine when the level of protection comprises the insufficient level, the program instructions direct the message system to determine when the level of protection comprises the insufficient level based at least on the threshold latency level and an actual latency level of at least one of the plurality of instances of the message volume.

13. The one or more computer readable media of claim 12 wherein the program instructions further direct the message system to determine the actual latency level provided by at least one of the plurality of instances of the message volume based at least on the condition information.

14. The one or more computer readable media of claim 9 wherein the protection criteria comprises a threshold redundancy level and a threshold latency level, and wherein to determine when the level of protection comprises the insufficient level the program instructions direct the message system to determine when the level of protection comprises the insufficient level based at least on the threshold redundancy level, an actual redundancy level, the threshold latency level, and an actual latency level.

15. The one or more computer readable media of claim 9 wherein the plurality of message systems provide an email service, wherein the message volume comprises an active email database associated with the email service, and wherein the plurality of instances of the message volume comprises a plurality of passive email databases to which the active email database is replicated, and wherein the protection action comprises an alert to a monitoring system indicative of the insufficient level of protection.

16. One or more computer readable media having stored thereon program instructions executable by a plurality of message systems to protect a message volume in a message replication environment, the program instructions comprising:
first server instructions that, when executed by a first message system of the plurality of message systems, direct the first message system to at least:
determine a first health of a first instance of a plurality of instances of the message volume hosted by the first message system;
determine a first health of a second instance of the plurality of instances of the message volume hosted by a second message system;
determine a first health of a third instance of the plurality of instances of the message volume hosted by a third message system;
determine if a first view of protection provided by the plurality of message systems is sufficient based on first redundancy criteria and the first health of the first instance, the second instance, and the third instance of the plurality of instances of the message volume; and
communicate a first alert if the first view of the protection is not sufficient.

17. The one or more computer readable media of claim 16 wherein the program instructions further comprise:
second server instructions that, when executed by the second message system of the plurality of message systems, direct the second message system to at least:
determine a second health of the second instance of the plurality of instances of the message volume hosted by the second message system;
determine a second health of the first instance of the plurality of instances of the message volume hosted by the first message system;
determine a second health of the third instance of the plurality of instances of the message volume hosted by the third message system;
determine if a second view of the protection provided by the plurality of message systems is sufficient based on second redundancy criteria and the second health of the first instance, the second instance, and the third instance of the plurality of instances of the message volume; and
communicate a second alert if the second view of the protection is not sufficient.

18. The one or more computer readable media of claim 17 wherein the first server instructions, when executed by the first message system, further direct the first message system to:
transfer first health information to the second message system indicating the first health of the first instance of the plurality of instances of the message volume; and
determine the first health of the second instance of the plurality of instances of the message volume based on the second health of the second instance indicated in second health information.

19. The one or more computer readable media of claim 18 wherein the second server instructions, when executed by the second message system, further direct the second message system to:
determine the second health of the first instance of the plurality of instances of the message volume based on the first health of the first instance indicated in the first health information; and
transfer the second health information to the first message system indicating the second health of the second instance of the plurality of instances of the message volume.

20. The one or more computer readable media of claim 16 wherein the plurality of message systems provide an email service, wherein the message volume comprises an active email database associated with the email service, and wherein the plurality of instances of the message volume comprises a plurality of passive email databases to which the active email database is replicated.
